(19) United States
(12) Patent Application Publication
(10) Pub. No.: US 2009/0210756 A1
(43) Pub. Date: Aug. 20, 2009

(54) FRAME RESTORATION METHOD, FRAME RESTORATION CIRCUIT, AND STORAGE MEDIUM

(76) Inventor: YASUKO MIKAMI, Tokyo (JP)

Correspondence Address: NEC CORPORATION OF AMERICA, 6535 N. STATE HWY 161, IRVING, TX, 75039, US

(21) Appl. No.: 12/370,737

(22) Filed: Feb. 13, 2009

(30) Foreign Application Priority Data
Feb. 14, 2008 (JP) 2008-032574

(51) Int. Cl. H04L 1/00; G06F 11/07

(52) U.S. Cl. 714/700; 714/E11.023

(57) ABSTRACT

A restoration frame identifier monitoring unit checks restoration frame identifiers within split frames and carries out processing to divide inputted split frames for input to a first split frame processing circuit or a second split frame processing circuit according to the value of the frame identifier and determines whether or not the split frames are inputted within a fixed monitoring time. The split frame accumulation buffer unit repeatedly accumulates inputted split frames until a split frame for a final frame is inputted. When the split frame for the final frame is inputted, this split frame and the accumulated split frames are combined so as to generate a single restored frame. The split frame accumulation buffer unit is then cleared when the split frames are not inputted within a fixed monitoring time.

This application is based on Japanese Patent Application No. 2008-032574 filed on Feb. 14, 2008 and including specification, claims, drawings and summary. The disclosure of which is incorporated herein by reference in its entirety.

### BACKGROUND OF THE INVENTION

1. Field of the Invention

The present invention relates to a flame restoration method, a flame restoration circuit, and a storage medium for storing a flame restoration program, and particularly relates to a flame restoration method, a frame restoration circuit, and a storage medium for storing a frame restoration program that sequentially receives a plurality of split frames for storage in a buffer, and restore the flames to a single flame for prior to splitting when all of the flames are gathered together.

2. Description of the Related Art

A frame restoration circuit is provided where, in order to transmit a single flame at high speed from a transmission side unit to a receiving side unit, identical restoration frame identifiers are respectively assigned to a plurality of the split flames that are split from the single frame. A receiving side unit sequentially receives the plurality of split flames and accumulates the plurality of split frames in a buffer. The flame restoration unit then restores the plurality of split flames having the same restoration frame identifier to the original single frame prior to splitting when all of the frames are gathered together. Such a flame restoration circuit is well-known and is disclosed in Unexamined Japanese Patent Application KOKAI Publication No. H7-177164.

In the flame restoration circuit disclosed in Unexamined Japanese Patent Application KOKAI Publication No. H7-177164, when the number of split flames having the same restoration flame identifier accumulated in the buffer does not reach a set number even after a fixed time elapses, it is assumed that some kind of fault has occurred at the receiving side unit and all of the split flames accumulated in the buffer are discarded. This means that the receiving processing therefore advances to the next flame and that stopping of the receiving processing is prevented.

### SUMMARY OF THE INVENTION

It is therefore an object of the present invention to provide a flame restoration method, a flame restoration circuit, and a storage medium for storing a flame restoration program that are applicable even when the split flames are a streamed signal.

It is a further object of the present invention to provide a frame restoration method, a frame restoration circuit, and a storage medium for storing a flame restoration program where it is possible to set a time for monitoring split flames every restored frame identifier.

In order to achieve the above object, a flame restoration method of the present invention is a flame restoration method that: receives as input individual split flames where one frame is split into a plurality of data, with each item of data being appended with a restoration frame identifier that is information identifying a flame to be restored, and a splitting identifier indicating splitting information; sequentially accumulates the inputted split frames; and combines the inputted split frames so as to restore them to the original one frame, comprising the steps of receiving the split flames as input, identifying values of the restoration frame identifiers within the split flames, and monitoring whether or not split flames with restoration flame identifiers of the same value are inputted within a time interval of a set fixed monitoring time, sequentially accumulating the split flames when the split flames are inputted within the time interval of the set fixed monitoring time, combining an accumulated plurality of split frames and generating a single restored frame after identifying a final flame of the split flames based on the splitting identifiers; and, discarding the accumulated split flames when the split flames are not inputted within the time interval of the set fixed monitoring time.

In order to achieve the above object, a frame restoration circuit of the present invention is a frame restoration circuit that: receives as input individual split frames where one frame is split into a plurality of data, with each item of data being appended with a restoration frame identifier that is information identifying a frame to be restored, and a splitting identifier indicating splitting information; sequentially accumulates the inputted split frames; and combines the inputted split frames so as to restore them to the original one frame, comprising an inputted split frame monitoring unit that receives the split frames as input, identifies values of the restoration frame identifiers within the split frames, and monitors whether or not split frames with restoration frame identifiers of the same value are inputted within a time interval of a set fixed monitoring time, and a split frame processing unit that sequentially accumulates the split frames, and combines the accumulated plurality of split frames so as to generate the single restored frame after identifying the final frame of the split frames based on the splitting identifiers when it is determined by the inputted split frame monitoring unit that the split frames are inputted within the time interval of the set fixed monitoring time, and discards the accumulated split frames when the inputted split frame monitoring unit determines that the split frames are not inputted within the time interval of the set fixed monitoring time.

In order to achieve the above object, a storage medium for storing a frame restoration program of the present invention is a storage medium for storing a frame restoration program for executing computer processing that receives as input individual split frames where one frame is split into a plurality of data, with each item of data being appended with a restoration frame identifier that is information identifying a frame to be restored, and a splitting identifier indicating splitting information, sequentially accumulates the inputted split frames, and then combines the inputted split frames so as to restore them to the original one frame, comprising a program executing processing for receiving the split frames as input, identifying values of the restoration frame identifiers within the split frames, and monitoring whether or not split frames with restoration frame identifiers of the same value are inputted within a time interval of a set fixed monitoring time, sequentially accumulating the split frames when the split frames are inputted within the time interval of the set fixed monitoring time, combining an accumulated plurality of split frames and generating a single restored frame after identifying a final frame of the split frames based on the splitting identifiers, and discarding the accumulated split frames when the split frames are not inputted within the time interval of the set fixed monitoring time.

According to the present invention, by monitoring whether or not split frames are inputted every fixed monitoring time, it is possible to avoid a situation where a frame restoration circuit becomes stuck as a result of the inputted split frames being dropped even when the split frames are a streamed signal and it is possible to set the monitoring time every inputted split frame signal type.

### BRIEF DESCRIPTION OF THE DRAWINGS

FIG. 1 is a block diagram showing an outline configuration for a frame restoration circuit of the present invention;

FIG. 2 is a block diagram of an embodiment of a frame restoration circuit of the present invention;

FIG. 3 is a structural view of an example of split frames inputted to the frame restoration circuit;

FIG. 4 is a flowchart illustrating an embodiment of a split frame restoration operation of the frame restoration circuit;

FIG. 5A is a view showing an example of a change over time in the buffer accumulation quantity of the split frame accumulation buffer unit when none of the split frames are dropped;

FIG. 5B is a diagram showing an example of monitoring conditions when none of the split frames are dropped;

FIG. 6A is a view showing an example of a change in time of the buffer accumulation quantity of the split frame accumulation buffer unit when a split frame is dropped;

FIG. 6B is a diagram showing an example of monitoring conditions when a split frame is dropped.

### DETAILED DESCRIPTION OF THE PREFERRED EMBODIMENTS

Next, a description is given of the embodiments of the present invention with reference to the drawings.

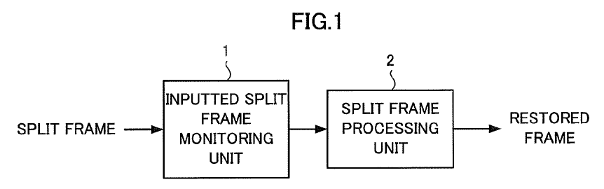

FIG. 1 is a block diagram showing an outline configuration for a flame restoration circuit of the present invention. As shown in FIG. 1, a flame restoration circuit includes an inputted split flame monitoring unit 1, and a split flame processing unit 2. Split flames inputted to the inputted split flame monitoring unit 1 are data where a single flame is split into a plurality of items of data. Each item of data is appended with a restoration flame identifier that is identification information for the flame to be restored to, and a splitting identifier indicating splitting information.

The inputted split flame monitoring unit 1 receives the split flames described above as input, and identifies values of restoration frame identifiers from within the inputted split flames. The inputted split flame monitoring unit 1 monitors whether or not split flames where the restoration flame identifiers are the same values are inputted within a time interval of a set fixed monitoring time.

The split flame processing unit 2 sequentially accumulates split flames determined to the inputted within the interval of the set fixed monitoring time by the inputted split frame monitoring unit 1. The split flame processing unit 2 then identifies a final flame of the split flames inputted based on the splitting identifier. After this, the split flame processing unit 2 combines the accumulated plurality of split flames so as to generate a single restored flame. The split flame processing unit 2 discards split flames accumulated up until this point when it is determined by the inputted split flame monitoring unit 1 that the split flames are not inputted within the time interval of the set fixed monitoring time.

When it is determined that the split flames are not inputted within the time interval of the set fixed monitoring time, the flame restoration circuit discards split flames having restoration frame identifiers of the same value as the split flames accumulated up until this point in the split flame processing unit 2. This prevents the flame restoration circuit from becoming stuck as a result of split flames being dropped. It is therefore possible to carry out processing of later inputted split frames having other restoration flame identifiers.

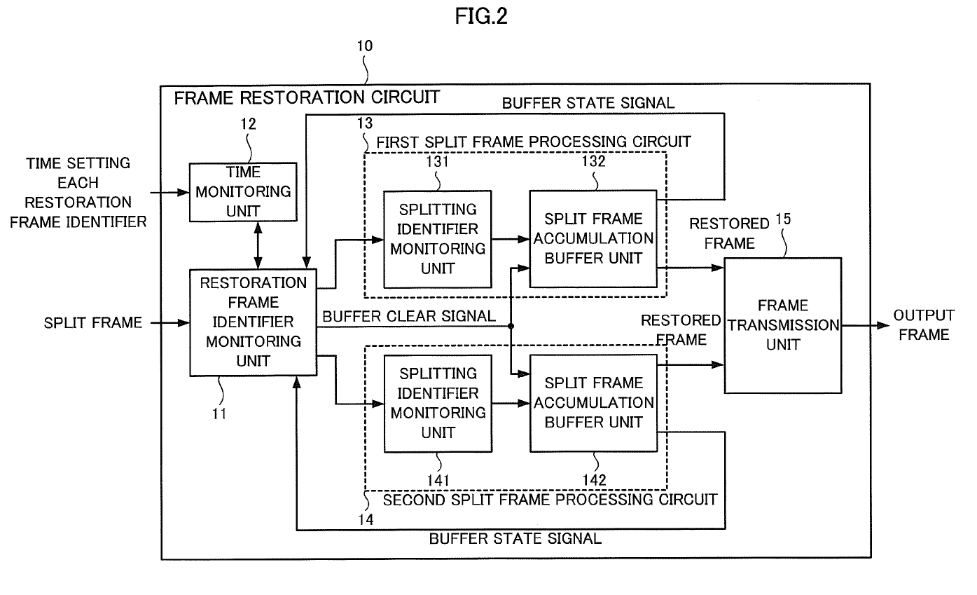

Next, a detailed explanation is given of the embodiments of the present invention using FIGS. 2 to 6.

FIG. 2 is a block diagram of an embodiment of a frame restoration circuit 10 of the present invention. The frame restoration circuit 10 of this embodiment includes a restoration frame identifier monitoring unit 11, a time monitoring unit 12, a first split frame processing circuit 13, a second split frame processing circuit 14, and a frame transmission unit 15. Each part of the flame restoration circuit 10 is constructed from hardware circuitry. The frame restoration circuit 10 can also be constructed from a ROM (read only memory) that stores a program for implementing functions of each unit, a CPU (Central Processing Unit) that reads in the program and carries out processing corresponding to each unit, and a RAM (Random Access Memory) that constitutes a work area for the CPU. The restoration frame identifier monitoring unit 11 monitors the frame identifiers of inputted split frame restoration. The time monitoring unit 12 manages monitoring time information for monitoring the time of split frames inputted to the restoration frame identifier monitoring unit 11. The first split frame processing circuit 13 and the second split frame processing circuit 14 take split frames outputted by the restoration frame identifier monitoring unit 11 as input. The frame transmission unit 15 takes restored frames restored by the first split frame processing circuit 13 and the second split frame processing circuit 14 as input. The restoration frame identifier monitoring unit 11 and the time monitoring unit 12 constitute the inputted split frame monitoring unit 1 of FIG. 1. The first split frame processing circuit 13 and the second split frame processing circuit 14 constitute the split frame processing unit 2 of FIG. 1.

The first split frame processing circuit 13 and the second split frame processing circuit 14 respectively include splitting identifier monitoring units 131 and 141, and split frame accumulation buffer units 132 or 142. The splitting identifier monitoring units 131 and 141 take split frames having two different types of restoration frame identifiers outputted by the restoration frame identifier monitoring unit 11 as input. The split frame accumulation buffer units 132 or 142 take split frames outputted by the splitting identifier monitoring units 131 and 141 and a buffer clear signal that is the result of observation of the restoration frame identifier monitoring unit 11 as input.

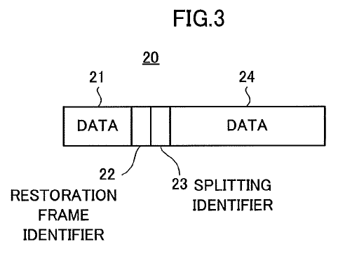

FIG. 3 is a structural view of an example of split frames inputted to the frame restoration circuit 10. Split frames 20 acquired by splitting one frame into a plurality of frames are configured in this embodiment through temporal synthesis (multiplexing) of data 21, restoration frame identifiers 22, splitting identifiers 23, and data 24, as shown in FIG. 3.

The data 21 and 24 is the data intended for transmission. The restoration frame identifier 22 is information for identifying which frame the split frames 20 have been split from, i.e. information for identifying restoration frames. Information for the type of signal, for example, is stored in the restoration frame identifier 22. The splitting identifier 23 indicates splitting information occurring at the split frames 20 and is information that makes it possible to identify whether a split frame 20 is a start frame or an end frame of a restoration frame.

The explanation now returns to FIG. 2. The restoration frame identifier monitoring unit 11 identifies which of the two types of values (which are n and m here) the restoration frame identifiers 22 within the inputted split frames 20 are, and distributes the split frames 20 for input to the first split frame processing circuit 13 or the second split frame processing circuit 14 in a manner corresponding to the identified restoration frame identifiers 22. The restoration frame identifier monitoring unit 11 has a function for changing the monitored/identified restoration frame identifiers 22 to separate new values in a predetermined order when a buffer state signal is inputted.

The time monitoring unit 12 manages monitoring time information for monitoring the time of split frames 20 inputted to the restoration frame identifier monitoring unit 11. It is possible to set the monitoring time every restoration flame identifier 22 at the restoration frame identifier monitoring unit 11. For example, a long monitoring time is set for signals that cannot be dropped (for example, dedicated line signals etc.) and a short monitoring time is set for signals for which retransmission is assumed (for example, TCP/IP (Transmission Control Protocol/Internet Protocol) signals). As a result, it is possible to perform frame restoration according to the transmission content and the service content.

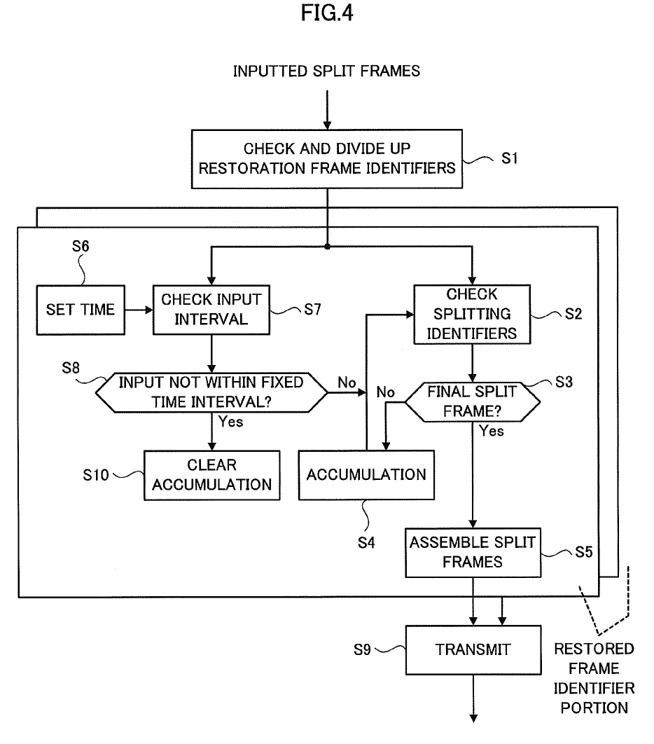

Next, a detailed explanation is given of the operation of this embodiment with reference to the flowchart of FIG. 4.

First, one frame is split into a plurality of frames, and each of the split frames 20 configured as in FIG. 3 are sequentially inputted to the restoration frame identifier monitoring unit 11. The restoration frame identifier monitoring unit 11 then checks the restoration frame identifiers 22 within the split frames 20 of the configuration shown in FIG. 3. If the value of the checked restoration frame identifier 22 is n, the restoration frame identifier monitoring unit 11 inputs this split frame 20 to the first split frame processing circuit 13. If the value of the checked restoration frame identifier 22 is m, the restoration frame identifier monitoring unit 11 inputs this split frame 20 to the second split frame processing circuit 14 (step S1). The operation of the first split flame processing circuit 13 and the second split flame processing circuit 14 is the same. To simplify the explanation, a case where the split frame 20 is inputted to the first split frame processing circuit 13 is only described here.

The splitting identifier monitoring unit 131 within the first split frame processing circuit 13 checks the splitting identifier 23 of the inputted split frame 20 (step S2) and determines whether or not this split frame 20 is a final frame (step S3). The splitting identifier monitoring unit 131 then supplies the split frame 20 to the split frame accumulation buffer unit 132 together with the determination results.

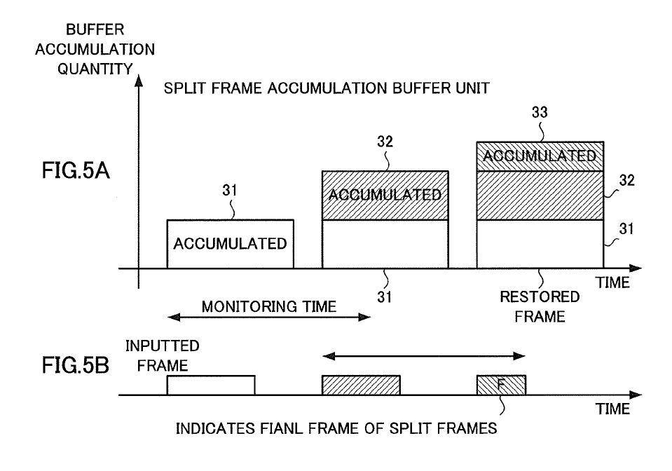

The split frame accumulation buffer units 132 accumulates the split frames 20 until the final split frame 20 is inputted (step S4). As a result, as shown schematically by numerals 31 and 32 in FIG. 5A, the buffer accumulation quantity of the split frame accumulation buffer unit 132 sequentially increases every time a split frame 20 is inputted.

Upon receiving determination results to the effect that the inputted split frame 20 is a final frame inputted in step S3, the split frame accumulation buffer unit 132 temporarily stores the split frame 20 that is a final frame, combines the final split frame 20 with the split frames 20 already accumulated, and reassembles the original one restored frame (step S5). Namely, the split frame accumulation buffer unit 132 only increases the buffer accumulation quantity by just a portion of the final frame during split frame input for the final frame as schematically shown by numeral 33 in FIG. 5A. The split flame accumulation buffer unit 132 assembles one restored frame which is in possession of the buffer accumulation quantity data amount for after the increase, corresponding to a restoration frame identifier n.

After this, the split flame accumulation buffer unit 132 outputs one assembled restored frame to the frame transmission unit 15 (step S9). The same operation as described above is also carried out at the second split flame processing circuit 14 and one restored frame corresponding to the restoration frame identifier m is outputted to the frame transmission unit 15. The frame transmission unit 15 carries out transmission control for the restored frames respectively supplied from the first split frame processing circuit 13 and the second split frame processing circuit 14 and outputs output frames.

In the above operation, when a split frame 20 is dropped during transmission in a situation where split frames 20 are accumulated at the split frame accumulation buffer units 132 or 142, split frames 20 having the same restoration frame identifiers n or m as the split frames 20 accumulated in the split frame accumulation buffer units 132 or 142 are not inputted. In this event, the split frame accumulation buffer units 132 of 142 enter a state of waiting for input for split frames 20 having the restoration frame identifiers n or m and the processing of the split frames 20 inputted from a new start frame it is no longer possible.

Therefore the time monitoring unit 12 manages the monitoring time for monitoring whether or not split frames 20 are inputted within a fixed time interval every restoration frame identifier 22 from the input of a time setting every restoration frame identifier 22 and supplies monitoring time information to the restoration frame identifier monitoring unit 11 (step S6). The restoration frame identifier monitoring unit 11 then monitors the input time interval for the split frames 20 based on this monitoring time information (step S7).

The restoration frame identifier monitoring unit 11 then monitors whether or not split frames 20 having restoration frame identifiers 22 of the same value are inputted sequentially within a fixed monitoring time t as shown schematically in FIG. 5B (step S8). Split frames 20 inputted within the fixed monitoring time t are inputted into the corresponding splitting identifier monitoring units 131 and 141 of the restoration frame identifiers n or m and splitting identifier checks are carried out (step S2).

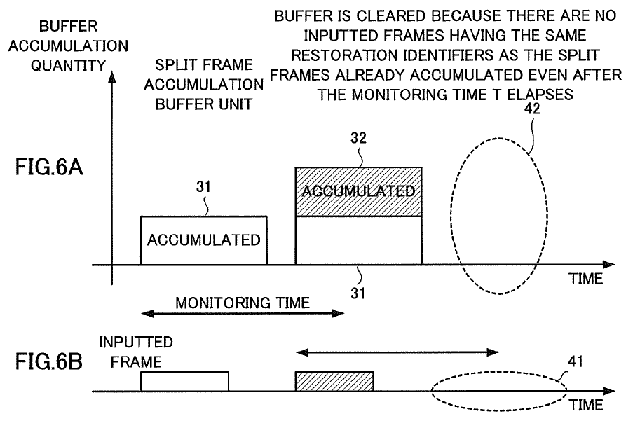

On the other hand, when the split frames 20 of restoration frame identifiers of the same value are not inputted within a fixed monitoring time t as shown schematically by 41 in FIG. 6B, the restoration frame identifier monitoring unit 11 supplies a buffer clear signal to the split frame accumulation buffer units 132 or 142 within the first split frame processing circuit 13 or the second split frame processing circuit 14 (step S10). As a result, as shown schematically by numeral 42 of FIG. 6A, the buffer accumulation quantity of the split frame accumulation buffer units 132 or 142 is cleared to become zero (the accumulated split frames 20 are discarded).

The cleared split frame accumulation buffer units 132 or 142 then supply a buffer state signal indicating that clearing has taken place to the restoration frame identifier monitoring unit 11. This means that the restoration frame identifier monitoring unit 11 replaces restoration frame identifiers 22 corresponding to the first split frame processing circuit 13 or the second split flame processing circuit 14 having a split frame accumulation buffer unit 132 or 142 that a buffer state signal is outputted from, sets new restoration frame identifiers that are next in an order set in advance, and starts identification of split frames for the new restoration frame identifiers.

In this way, the frame restoration circuit 10 of this embodiment monitors whether or not split frames 20 having restoration frame identifiers 22 of the same value are inputted within the fixed monitoring time t. When the split frames 20 having the same restoration frame identifiers 22 that are accumulated in the split frame accumulation buffer units 132 or 142 are not inputted within the fixed monitoring time t, the frame restoration circuit 10 clears the split frame accumulation buffer units 132 or 142 accumulating the split frames 20 without waiting for input of the final frame of the split frames 20. This means that according to the flame restoration circuit 10 of this embodiment, the frame restoration circuit 10 can be prevented from becoming stuck as a result of dropped split frames 20 and it is possible to carry out processing of split frames having other restoration frame identifiers.

In this embodiment, the restoration frame identifier monitoring unit 11 monitors whether or not split frames 20 having restoration frame identifiers 22 of the same value are inputted within the fixed monitoring time t. This embodiment is therefore also applicable to the case of streamed signals where it is demanded that the split frames 20 are inputted within a fixed time interval.

In this embodiment, it is further possible to set the monitoring time every restoration frame identifier 22, set a long monitoring time for signals where dropping is not acceptable, and set a short monitoring time for signals where retransmission is assumed, using the time monitoring unit 12. It is therefore possible to change the monitoring time until the buffer accumulation quantity of the split frame accumulation buffer units 132 or 142 is cleared according to the type of split frame 20. As a result, according to this embodiment, a frame restoration corresponding to the transmission content and service content is possible.

The present invention is by no means limited to the above embodiments. For example, in the embodiment of FIG. 2, two split frame processing circuits are provided but the present invention is by no means limited in this respect and an arbitrary number of split frame processing circuits can also be provided. The present invention is also applicable to interfaces other than bus interfaces.

The present invention also includes a storage medium for storing a frame restoration program executed by a computer so as to implement the processing shown in a flowchart of FIG. 4 for the split frame accumulation buffer units 132 or 142.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A frame restoration method that: receives as input individual split frames where one frame is split into a plurality of data, with each item of data being appended with a restoration frame identifier that is information identifying a frame to be restored, and a splitting identifier indicating splitting information; sequentially accumulates the inputted split frames; and then combines the inputted split frames so as to restore them to the original one frame, comprising the steps of:
receiving the split frames as input, identifying values of the restoration frame identifiers within the split frames, and monitoring whether or not split frames with restoration frame identifiers of the same value are inputted within a time interval of a set fixed monitoring time;
sequentially accumulating the split frames when the split frames are inputted within the time interval of the set fixed monitoring time;
combining an accumulated plurality of split flames and generating a single restored flame after identifying a final frame of the split frames based on the splitting identifiers; and
discarding the accumulated split frames when the split frames are not inputted within the time interval of the set fixed monitoring time.

2. The frame restoration method according to claim 1,
wherein identification of values for the restoration frame identifiers within the split frames is changed so as to be carried out for split frames of restoration frame identifiers of preset values differing to the values of the restoration frame identifiers identified up to this point, after discarding the accumulated split frames when the split frames are not inputted within the time interval of the set fixed monitoring time.

3. A frame restoration method that: receives as input individual split frames where one frame is split into a plurality of data, with each item of data being appended with a restoration frame identifier that is information identifying a frame to be restored, and a splitting identifier indicating splitting information; sequentially accumulates the inputted split frames; and combines the inputted split frames so as to restore them to the original one frame, comprising the steps of:
setting a split frame monitoring time;
identifying values of the restoration frame identifiers within the inputted split frames, and monitoring whether or not split frames with restoration frame identifiers of the same value are inputted within a time interval of a set fixed monitoring time;
determining whether or not the split frame is the final frame based on the splitting identifiers when the split frames are inputted within the time interval of the set fixed monitoring time;
sequentially accumulating split frames determined not to be the final frame;
combining the split frame that is the final frame with the split frames accumulated up to this point and generating a restored frame when a split frame determined to be the final frame is inputted; and
discarding the split frames accumulated up to this point when the split frames are not inputted within the time interval of the set fixed monitoring time.

4. The frame restoration method according to claim 3, wherein identification of values for the restoration frame identifiers within the split frames is changed so as to be carried out for split frames of restoration frame identifiers of preset values differing to the values of the restoration frame identifiers identified up to this point after discarding the accumulated split frames when the split frames are not inputted within the time interval of the set fixed monitoring time.

5. The frame restoration method according to claim 3, wherein the monitoring time is arbitrarily set every type of the split frame where the values of the restoration frame identifiers are different.

6. A flame restoration circuit that: receives as input individual split flames where one flame is split into a plurality of data, with each item of data being appended with a restoration flame identifier that is information identifying a flame to be restored, and a splitting identifier indicating splitting information; sequentially accumulates the inputted split flames; and then combines the inputted split flames so as to restore them to the original one flame, comprising:
an inputted split flame monitoring unit that receives the split flames as input, identifies values of the restoration frame identifiers within the split frames, and monitors whether or not split flames with restoration frame identifiers of the same value are inputted within a time interval of a set fixed monitoring time; and
a split flame processing unit that sequentially accumulates the split frames, and combines the accumulated plurality of split flames so as to generate the single restored flame after identifying the final flame of the split frames based on the splitting identifiers when it is determined by the inputted split flame monitoring unit that the split flames are inputted within the time interval of the set fixed monitoring time, and discards the accumulated split flames when the inputted split frame monitoring unit determines that the split frames are not inputted within the time interval of the set fixed monitoring time.

7. The flame restoration circuit according to claim 6, wherein after discarding the split flames accumulated by the split flame processing unit, the inputted split flame monitoring unit changes identification of values for the restoration frame identifiers within the split flames so as to be carried out for split flames of restoration flame identifiers of preset values differing to the values of the restoration flame identifiers identified up to this point.

8. A flame restoration circuit that: receives as input individual split flames where one flame is split into a plurality of data, with each item of data being appended with a restoration flame identifier that is information identifying a flame to be restored, and a splitting identifier indicating splitting information; sequentially accumulates the inputted split flames; and combines the inputted split frames so as to restore them to the original one flame, comprising:
a restoration flame identifier monitoring unit that identifies values of the restoration flame identifiers within the inputted split flames, and monitors whether or not split flames with restoration flame identifiers of the same value are inputted within a time interval of a set fixed monitoring time;
a time monitoring unit that sets a fixed monitoring time that the restoration flame identifier monitoring unit monitors for;
a splitting identifier monitoring unit that determines whether or not a split flame is a final flame based on the splitting identifiers when the restoration flame identifier monitoring unit determines that the split flames are inputted within the time interval of the set fixed monitoring time;
a buffer unit that sequentially accumulates split flames determined not to be the final flame by the splitting identifier monitoring unit, and combines a split flame for the final frame with the split frames accumulated up to this point and generates a restored flame when a split frame determined to be the final flame by the splitting identifier monitoring unit is inputted, and discards the split flames accumulated up to this point when the restoration flame identifier monitoring unit determines that the split flames are not inputted within the time interval of the set fixed monitoring time.

9. The flame restoration circuit according to claim 8,
having a plurality of sets of split frame processing units constituted by the splitting identifier monitoring units and the buffer units, and further comprising a transmission unit for transmitting a plurality of the restored frames outputted from the buffer units within the plurality of sets of split flame processing unit collectively as output flames,
and the restoration frame identifier monitoring unit comprises:
a dividing input function that divides inputted split frames between the plurality of sets off the split frame processing units according to the values of the identified restoration frame identifiers for input; and
a function for discarding the split frames accumulated up to this point only for the buffer units within split frame processing units, of the plurality of sets of split frame processing units, corresponding to values for the restoration frame identifiers of the split frames that are not inputted within the time interval of the set fixed monitoring time.

10. The frame restoration circuit according to claim 8, wherein after discarding the split frames accumulated by the split frame processing unit, the inputted split frame monitoring unit changes identification of values for the restoration frame identifiers within the split frames so as to be carried out for split frames of restoration frame identifiers of preset values differing to the values of the restoration frame identifiers identified up to this point.

11. The frame restoration circuit according to claim 8, wherein the time monitoring unit sets the monitoring time arbitrarily each type of the split frame where the value of the restoration frame identifiers are different.

12. A storage medium for storing a frame restoration program for executing computer processing that: receives as input individual split frames where one frame is split into a plurality of data, with each item of data being appended with a restoration frame identifier that is information identifying a frame to be restored, and a splitting identifier indicating splitting information; sequentially accumulates the inputted split frames; and then combines the inputted split frames so as to restore them to the original one frame, the program executing processing on a computer for:
receiving the split frames as input, identifying values of the restoration frame identifiers within the split frames, and monitoring whether or not split frames with restoration frame identifiers of the same value are inputted within a time interval of a set fixed monitoring time;
sequentially accumulating the split frames when the split frames are inputted within the time interval of the set fixed monitoring time;
combining an accumulated plurality of split frames and generating a single restored frame after identifying a final frame of the split frames based on the splitting identifiers; and
discarding the accumulated split frames when the split frames are not inputted within the time interval of the set fixed monitoring time.

13. The storage medium according to claim 12, wherein processing is executed on a computer in order to change identification of values for the restoration frame identifiers within the split frames so as to be carried out for split frames of restoration frame identifiers of preset values differing to the values of the restoration frame identifiers identified up to this point, after discarding the accumulated split frames when the split frames are not inputted within the time interval of the set fixed monitoring time.

14. A storage medium for storing a frame restoration program for executing processing on a computer that receives as input individual split frames where one frame is split into a plurality of data, with each item of data being appended with a restoration frame identifier that is information identifying a frame to be restored, and a splitting identifier indicating splitting information, sequentially accumulates the inputted split frames, and then combines the inputted split frames so as to restore them to the original one frame, executing on the computer processing for:
setting a time of monitoring the split frames;
identifying values of the restoration frame identifiers within the inputted split frames, and monitoring whether or not split frames with restoration frame identifiers of the same value are inputted within a time interval of a set fixed monitoring time;
determining whether or not a split frame is a final frame based on the splitting identifiers when the split frames are inputted within the time interval of the set fixed monitoring time;
sequentially accumulating split frames determined not to be final frames;
combining the split frame for the final frame with the split frames accumulated up to this point and generating a restoration frame when a split frame determined to be for the final frame is inputted; and
discarding the split frames accumulated up to this point when the split flames are not inputted within the time interval of the set fixed monitoring time.

15. The storage medium according to claim 14, wherein processing is executed on a computer in order to change identification of values for the restoration frame identifiers within the split frames so as to be carried out for split frames of restoration frame identifiers of preset values differing to the values of the restoration frame identifiers identified up to this point, after discarding the accumulated split frames when the split frames are not inputted within the time interval of the set fixed monitoring time.

16. The storage medium according to claim 15, wherein processing to arbitrarily set the monitoring time with respect to each type of the split frame where the value of the restoration frame identifiers are different is executed by the program on a computer.
